(19) United States
(12) Patent Application Publication
(10) Pub. No.: US 2015/0330104 A1
(43) Pub. Date: Nov. 19, 2015

(54) CODED LOCK

(71) Applicant: YIFENG MANUFACTURING CO., LTD., Dongguan City (CN)

(72) Inventor: Leo LAI, Dongguan City (CN)

(73) Assignee: YIFENG MANUFACTURING CO., LTD., Dongguan City (CN)

(21) Appl. No.: 14/275,940

(22) Filed: May 13, 2014

(51) Int. Cl. E05B 37/00

(52) U.S. Cl. CPC E05B 37/0034

(57) ABSTRACT

A coded lock comprises a base plate and a housing which are fixedly connected with each other; the base plate is provided with a password mechanism, a key lock assembly and latch hook assemblies and further includes a clutch block and a push switch; the push switch is connected with the latch hook assemblies; the clutch block is clamped with the push switch and may perform longitudinal movement relative to the push switch; the key lock assembly is provided with a driving rod for driving the clutch block to perform longitudinal movement; the password mechanism is provided with a movable plate which is provided with a clamping groove clamped with the clutch block; the coded lock is provided with an elastic member for pushing the clutch block towards the clamping groove; and in the case of password unlocking, the movable plate moves and pushes the clutch block away from the clamping groove.

### FIELD OF THE INVENTION

The present invention belongs to the technical field of mechanical locks, in particular relates to a coded lock.

### BACKGROUND OF THE INVENTION

Coded locks are widely applied to cases and bags, e.g., zipper pulls of the cases and bags. When the coded locks are applied, due to the unreasonable structural design, the coded locks are inconvenient to use and the occupied volume is very large. For instance, in the Chinese utility model patent Appl. No. 201220744304.5, titled “zipper coded lock”, the zipper coded lock mainly adopts a left push block and a right push block to push latch hooks to move and hence controls the latch hooks on both sides to be in the locked state. When the two push blocks are adopted, the two push blocks are disposed at both ends of a housing, and hence the occupied volume can be very large. Moreover, when the zipper coded lock is used, reverse pressing is required, and hence the operation is inconvenient at all.

### SUMMARY OF THE INVENTION

The present invention provides a coded lock to overcome the defect of inconvenient use due to the unreasonable structure of the traditional coded lock in the prior art. The coded lock can achieve the unlocking process on both sides via a push switch, and hence the operation is convenient.

The present invention adopts the technical proposal that:

The present invention relates to a coded lock, which comprises a base plate and a housing which are fixedly connected with each other; the base plate is provided with a password mechanism, a key lock assembly and latch hook assemblies; the coded lock further comprises a clutch block and a push switch; the push switch is connected with the latch hook assemblies; the clutch block is clamped with the push switch and may perform longitudinal movement relative to the push switch; the key lock assembly is provided with a driving rod for driving the clutch block to perform longitudinal movement; the password mechanism is provided with a movable plate which is provided with a clamping groove clamped with the clutch block; the coded lock is provided with an elastic member for pushing the clutch towards the clamping groove; and in the case of password unlocking, the movable plate moves and pushes the clutch block away from the clamping groove.

In the case of locking, the elastic member is configured to push the clutch block towards the clamping groove, so that the clutch block can be clamped with the clamping groove. At this point, the clutch block is limited; and as the clutch block and the push switch are in the clamped state, the push switch is also limited. Therefore, the push switch cannot drive the latch hook assemblies to move, and hence the locking process can be achieved.

In the case of unlocking, firstly, password unlocking: the movable plate of the password mechanism moves and pushes the clutch block away from the clamping groove; the push switch and the clutch block may move together; and hence the push switch may be pushed to unlock the coded lock. Secondly, key unlocking: the driving rod of the key lock assembly drives the clutch block to perform longitudinal movement and be away from the clamping groove; at this point, the push switch and the clutch block may move together; and hence the unlocking process can be achieved.

Moreover, one side of the clamping groove is provided with an inclined surface or a curved surface which helps to push the clutch block away from the clamping groove.

Moreover, the base plate is provided with two latch hook assemblies which are respectively disposed on two sides of the push switch; the latch hook assembly includes a push rod and a latch hook; the push rod is provided with a connecting body connected with a connecting portion of the push switch and is provided with a plurality of movable recesses; the latch hook includes a limited portion and a hook portion; the limited portions are disposed in the movable recesses; the housing is provided with clamping holes matched with the hook portions; in the case of unlocking and after unlocking, when the push switch is pushed to the left, one latch hook assembly is in the unlocked state and the other latch hook assembly is in the locked state; and when the push switch is pushed to the right, one latch hook assembly is in the locked state and the other latch hook assembly is in the unlocked state.

Moreover, the clutch block includes a longitudinally arranged vertical block; a control portion matched with the driving rod is extended out of the vertical block; the push switch includes a pushing portion on the upper end and a connecting portion at the lower end; and the connecting portion is provided with a moving groove matched with the vertical block.

Furthermore, the key lock assembly includes a lock core; a mounting hole for mounting the lock core is formed at the left end of the connecting portion and runs through the pushing portion; the lock core is disposed in the mounting hole; the driving rod is connected to the right side of the lock core; the connecting portion is provided with an accommodating hole for accommodating the lock core and the control portion of the clutch block; and the driving rod is disposed on one side of the control portion close to the password mechanism.

Furthermore, a rotating block is disposed between the lock core and the base plate and connected with the lock core; and the driving rod is disposed on the rotating block.

Moreover, the latch hook assembly includes a push rod and a latch hook; the push rod is provided with a connecting body connected with the connecting portion of the push switch and is provided with a plurality of movable recesses; the latch hook includes a limited portion and a hook portion; the limited portions are disposed in the movable recesses; and the housing is provided with clamping holes matched with the hook portions.

Moreover, the password mechanism further includes a plurality of wheelsets; the movable plate is provided with clamping pieces matched with the wheelsets; the wheelset is disposed on one side of the clamping piece and includes a password wheel and a password adjustment wheel; the clamping piece is provided with a clamping block protruded along the direction of the wheelset; the password adjustment wheel is provided with a concave hole matched with the clamping block; the password wheel is connected to the password adjustment wheel; the housing is provided with password adjustment holes for exposing the password wheels; and the wheelsets are movably connected with the base plate or the housing and may rotate relative to the base plate.

Moreover, the wheelsets are split structures; the code lock further comprises a password adjustment mechanism; the movable plate further includes a connecting block and a clamping block; the clamping pieces are connected to one side of the connecting block far away from the push switch and the clamping block is connected to the other side of the connecting block; the password adjustment mechanism includes a password adjustment block; and one end of the password adjustment block is extended out of the housing and the other end of the password adjustment block is disposed on one side of the clamping block.

Moreover, the base plate is provided with a plurality of latch hook assemblies; one latch hook assembly is disposed on the other side of the connecting block; a through hole for moving the password adjustment block is formed at the lower end of the push rod of the latch hook assembly; the push rod is provided with a sloping block for pushing out the password adjustment block; and the password adjustment block is provided with a push-out inclined surface matched with the sloping block.

The coded lock provided by the present invention has the advantage that: as the technical proposal may adopt the push switch for horizontal switching, the coded lock is very convenient to use.

### BRIEF DESCRIPTION OF THE DRAWINGS

FIG. 1 is a schematic structural view of a coded block provided by the present invention;

FIG. 2 is a schematic structural view of the coded block provided by the present invention in which a housing is removed;

FIG. 3 is a schematic structural view of FIG. 2 in which a push switch is removed;

FIG. 4 is a schematic structural exploded view of the coded block provided by the present invention;

FIG. 5 is a schematic diagram illustrating the engagement between the push switch and a clutch block;

FIG. 6 is a schematic diagram of the push switch;

FIG. 7 is a schematic diagram of the clutch block;

FIG. 8 is a schematic structural view of one push rod;

FIG. 9 is a schematic structural view of a latch hook; and

FIG. 10 is a schematic structural view of a movable plate.

### REFERENCE NUMERALS OF THE ACCOMPANYING DRAWINGS

| | | |
|---|---|---|
| 1—Housing | 2—Password Wheel | 3—Push Switch |
| 4—Base Plate | 5—Password Adjustment Block | 6—Push Rod |
| 7—Latch Hook | 8—Movable Plate | 9—Lock Core |
| 10—Driving Rod | 11—Clutch Block | 12—Password Adjustment Wheel |
| 13—Bottom Shell | 61—Connecting Body | 31—Pushing Portion |
| 32—Connecting Portion | 14—Elastic member | 321—Moving Groove |
| 111—Control Portion | 112—Vertical Block | |
| 62—Recess | 71—Hook Portion | 72—Limited Portion |

### DETAILED DESCRIPTION OF THE PREFERRED EMBODIMENTS

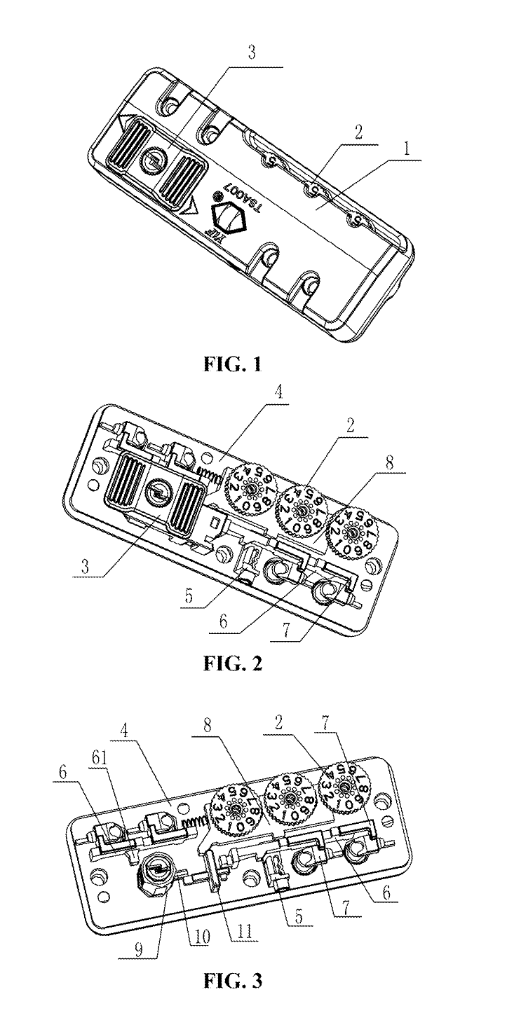

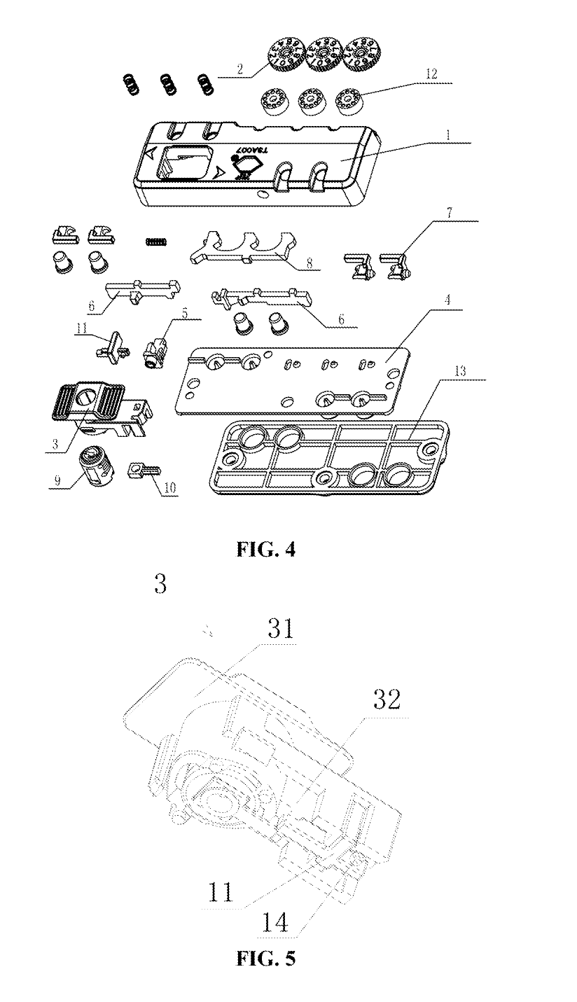

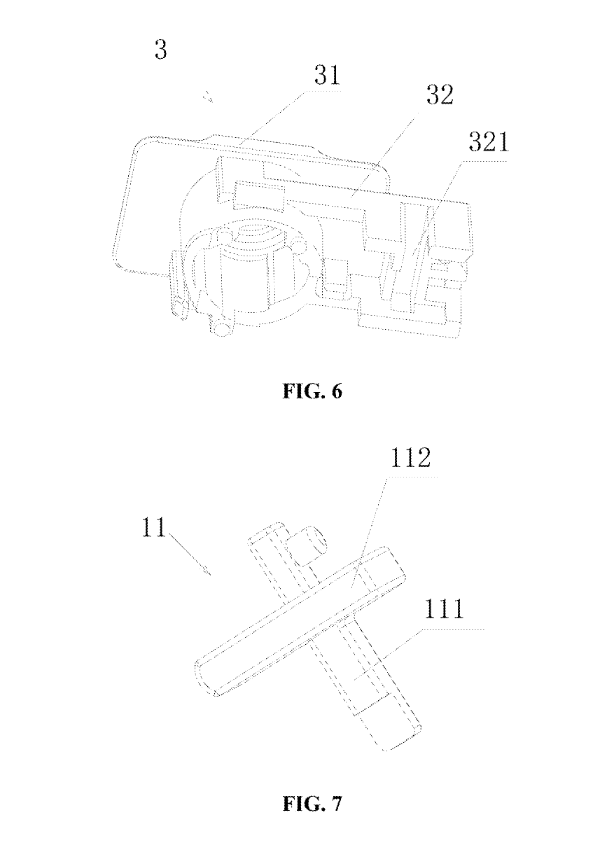

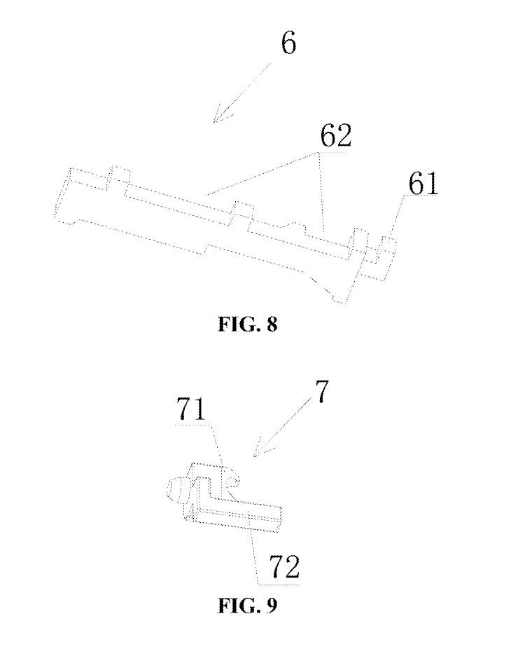

Embodiments: as shown in FIGS. 1 to 10.

The present invention relates to a coded lock, which comprises a base plate 4 and a housing 1 which are connected with each other; the base plate 4 is provided with a password mechanism, a key lock assembly and latch hook assemblies; the coded lock further comprises a clutch block 11 and a push switch 3; the push switch 3 is connected with the latch hook assemblies; the clutch block 11 is clamped with the push switch 3 and may perform longitudinal movement relative to the push switch 3; the key lock assembly is provided with a driving rod 10 for driving the clutch block 11 to perform longitudinal movement; the password mechanism is provided with a movable plate 8 which is provided with a clamping groove clamped with the clutch block 11; the coded lock is provided with an elastic member 14 for pushing the clutch block 11 towards the clamping groove; and in the case of password unlocking, the movable plate 8 moves and pushes the clutch block 11 away from the clamping groove. The elastic member 14 may adopt a spring.

In the case of locking, the elastic member 14 is configured to push the clutch block 11 towards the clamping groove, so that the clutch block 11 can be clamped with the clamping groove. At this point, the clutch block 11 is limited; and as the clutch block 11 and the push switch 3 are in the clamped state, the push switch 3 is also limited. Therefore, the push switch 3 cannot drive the latch hook assemblies to move, and hence the locking process can be achieved.

In the case of unlocking, firstly, password unlocking: the movable plate 8 of the password mechanism moves and pushes the clutch block 11 away from the clamping groove; the push switch 3 and the clutch block 11 may move together; and hence the push switch 3 may be pushed to unlock the coded lock. Secondly, key unlocking: the driving rod 10 of the key lock assembly drives the clutch block 11 to perform longitudinal movement and be away from the clamping groove; at this point, the push switch 3 and the clutch block 11 may move together; and hence the unlocking process can be achieved.

Moreover, one side of the clamping groove is provided with an inclined surface or a curved surface which helps to push the clutch block 11 away from the clamping groove.

In the case of password unlocking, the movable plate 8 moves and the inclined surface or the curved surface abuts against the clutch block 11 and pushes the clutch block 11 away from the clamping groove.

Moreover, the base plate 4 is provided with two latch hook assemblies which are respectively disposed on two sides of the push switch 3; the latch hook assembly includes a push rod 6 and a latch hook 7; the push rod 6 is provided with a connecting body 61 connected with a connecting portion 32 of the push switch 3 and is provided with a plurality of movable recesses 62; the latch hook 7 includes a limited portion 72 and a hook portion 71; the limited portions 72 are disposed in the movable recesses 62; the housing 1 is provided with clamping holes matched with the hook portions 71; in the case of unlocking and after unlocking, when the push switch 3 is pushed to the left, one latch hook assembly is in the unlocked state and the other latch hook assembly is in the locked state; and when the push switch 3 is pushed to the right, one latch hook assembly is in the locked state and the other latch hook assembly is in the unlocked state. The two sides illustrated herein refer to that the latch hook assemblies are disposed on two sides among the left side, the right side, the upper side and the lower side of the push switch 3.

In order to unlock the coded lock through the push switch 3 after unlocking, the length between the limited portion 72 and the movable recess 62 may be adjusted. For instance, when the push switch 3 moves to the right, the right end of the movable recess 62 on the latch hook assembly on the left side is disposed on the right side of the limited portion 72; and at this point, the hook portion 71 may be driven to move to the right, and hence the unlocking process can be achieved. But the left end of the movable recess 62 on the latch hook assembly on the upper side abuts against the limited portion 72, and the hook portion 71 cannot move and hence the coded lock is in the locked state. When the push switch 3 moves to the left, the state of the push switch 3 can be derived. When the push switch 3 does not move, both the hook portions 71 of the two latch hooks 7 may be pushed but only one part can be moved, and hence the coded lock cannot be in the unlocked state; and the coded lock can be in the completely unlocked state only after the push switch 3 moves.

Moreover, the clutch block 11 includes a longitudinally arranged vertical block 112; a control portion 111 matched with the driving rod 10 is extended out of the vertical block 112; the push switch 3 includes a pushing portion 31 on the upper end and a connecting portion 32 at the lower end; and the connecting portion 32 is provided with a moving groove 321 matched with the vertical block 112.

Furthermore, the key lock assembly includes a lock core 9; a mounting hole for mounting the lock core 9 is formed at the left end of the connecting portion 32 and runs through the pushing portion 31; the lock core 9 is disposed in the mounting hole; the driving rod 10 is connected to the right side of the lock core 9; the connecting portion 32 is provided with an accommodating hole for accommodating the lock core 9 and the control portion 111 of the clutch block 11; and the driving rod 10 is disposed on one side of the control portion 111 close to the password mechanism.

Furthermore, a rotating block is disposed between the lock core 9 and the base plate 4 and connected with the lock core 9; and the driving rod 10 is disposed on the rotating block. Split structures are adopted herein.

As a deformation of the present invention, moreover, the latch hook assembly includes a push rod 6 and a latch hook 7; the push rod 6 is provided with a connecting body 61 connected with the connecting portion 32 of the push switch 3 and is provided with a plurality of movable recesses 62; the latch hook 7 includes a limited portion 72 and a hook portion 71; the limited portions 72 are disposed in the movable recesses 62; and the housing 1 is provided with clamping holes matched with the hook portions 71. The base plate 4 is provided with a plurality of latch hook assemblies; one latch hook assembly is disposed on one side of the connecting block; a through hole for moving a password adjustment block 5 is formed at the lower end of the push rod 6 of the latch hook assembly; the push rod 6 is provided with a sloping block for pushing out the password adjustment block 5; and the password adjustment block 5 is provided with a push-out inclined surface matched with the sloping block.

The coded lock may be only provided with one latch hook assembly and may also be provided with a plurality of latch hook assemblies, for instance, disposed on the left side, the right side, the upper side, the lower side and the like of the push switch 3.

Moreover, the password mechanism further includes a plurality of wheelsets; the movable plate 8 is provided with clamping pieces matched with the wheelsets; the wheelset is disposed on one side of the clamping piece and includes a password wheel 2 and a password adjustment wheel 12; the clamping piece is provided with a clamping block protruded along the direction of the wheelset; the password adjustment wheel is provided with a concave hole matched with the clamping block; the password wheel 2 is connected to the password adjustment wheel 12; the housing 1 is provided with password adjustment holes for exposing the password wheels 2; and the wheelsets are movably connected with the base plate 4 or the housing 1 and may rotate relative to the base plate 4.

Moreover, the wheelsets are split structures; the coded lock further comprises a password adjustment mechanism; the movable plate 8 further includes a connecting block and a clamping block; the clamping piece is connected to one side of the connecting block far away from the push switch 3; the clamping block is connected to the other side of the connecting block; the password adjustment mechanism includes a password adjustment block 5; and one end of the password adjustment block 5 is extended out of the housing 1 and the other end of the password adjustment block 5 is disposed on one side of the clamping block.

Furthermore, the password mechanism may also adopt other structures. For instance, the password mechanism includes a plurality of wheelsets and a shaft lever; the shaft lever is sleeved in the wheelsets and connected with the movable plate 8; an offsetting spring is disposed between the shaft lever and a bottom shell 13; when the password of the wheelset is correct, the shaft lever may perform transverse movement under the action of the offsetting spring, namely the movable plate 8 may perform transverse movement; and hence the clutch block 11 may be pushed transversely away from the clamping groove. The movable plate 8 is provided with an inclined surface for pushing the clutch block 11 away from the clamping groove, on the end portion of the clamping groove.

Projections which are linearly distributed and arranged corresponding to the wheelsets are formed on a side surface of the shaft lever; the wheelset includes a password wheel 2 and a password adjustment wheel 12; the password wheel 2 is sleeved on the outside of the password adjustment wheel 12; and the password adjustment wheel 12 is provided with a clamping groove matched with the projection. The password mechanism is similar to a cipher device with the Patent No. 201110384615.5.

1. A coded lock, comprising:
a base plate comprising:
a password mechanism,
a key lock assembly,
and latch hook assemblies,
a housing fixedly connected with the base plate;
a clutch block;
a push switch connected with the latch hook assemblies and clamped with the clutch block so as to perform longitudinal movement with the clutch block; wherein the key lock assembly is provided with a driving rod for driving the clutch block to perform longitudinal movement; the password mechanism is provided with a movable plate which is clamped with the clutch block; and
an elastic member for pushing the clutch block and in the case of password unlocking, the movable plate moves and pushes the clutch block.

2. The coded lock according to claim 1, wherein the clutch block includes a longitudinally arranged vertical block; a control portion matched with the driving rod is extended out of the vertical block; the push switch includes a pushing portion on the upper end and a connecting portion at the lower end; and
the connecting portion is provided with a moving groove matched with the vertical block.

3. The coded lock according to claim 2, wherein the key lock assembly includes a lock core; a mounting hole for mounting the lock core is formed at the left end of the connecting portion and runs through the pushing portion; the lock core is disposed in the mounting hole; the driving rod is connected to the right side of the lock core; the connecting portion is provided with an accommodating hole for accommodating the lock core and the control portion of the clutch block;
and the driving rod is disposed on one side of the control portion close to the password mechanism.

4. The coded lock according to claim 3, wherein a rotating block is disposed between the lock core and the base plate and connected with the lock core; and the driving rod is disposed on the rotating block.

5. The coded lock according to claim 1, further comprising an inclined surface or a curved surface which helps to push the clutch.

6. The coded lock according to claim 5, wherein the clutch block includes a longitudinally arranged vertical block; a control portion matched with the driving rod is extended out of the vertical block; the push switch includes a pushing portion on the upper end and a connecting portion at the lower end; and the connecting portion is provided with a moving groove matched with the vertical block.

7. The coded lock according to claim 6, wherein the key lock assembly includes a lock core; a mounting hole for mounting the lock core is formed at the left end of the connecting portion and runs through the pushing portion; the lock core is disposed in the mounting hole; the driving rod is connected to the right side of the lock core; the connecting portion is provided with an accommodating hole for accommodating the lock core and the control portion of the clutch block; and the driving rod is disposed on one side of the control portion close to the password mechanism.

8. The coded lock according to claim 7, wherein a rotating block is disposed between the lock core and the base plate and connected with the lock core; and the driving rod is disposed on the rotating block.

9. The coded lock according to claim 1, wherein the password mechanism further includes a plurality of wheelsets; the movable plate is provided with clamping pieces matched with the wheelsets; the wheelset is disposed on one side of the clamping piece and includes a password wheel and a password adjustment wheel; the clamping piece is provided with a clamping block protruded along the direction of the wheelset; the password adjustment wheel is provided with a concave hole matched with the clamping block; the password wheel is connected to the password adjustment wheel; the housing is provided with password adjustment holes for exposing the password wheels; and the wheelsets are movably connected with the base plate or the housing and may rotate relative to the base plate.

10. The coded lock according to claim 9, wherein the wheelsets are split structures; the code lock further comprises a password adjustment mechanism; the movable plate further includes a connecting block and a clamping block; the clamping pieces are connected to one side of the connecting block far away from the push switch and the clamping block is connected to the other side of the connecting block; the password adjustment mechanism includes a password adjustment block; and one end of the password adjustment block is extended out of the housing and the other end of the password adjustment block is disposed on one side of the clamping block.

11. The coded lock according to claim 1, wherein the latch hook assembly includes a push rod and a latch hook; the push rod is provided with a connecting body connected with the connecting portion of the push switch and is provided with a plurality of movable recesses; the latch hook includes a limited portion and a hook portion; the limited portions are disposed in the movable recesses; and the housing is provided with clamping holes matched with the hook portions.

12. The coded lock according to claim 11, wherein one latch hook assembly is disposed on the other side of the connecting block; a through hole for moving the password adjustment block is formed at the lower end of the push rod of the one latch hook assembly; the push rod is provided with a sloping block for pushing out the password adjustment block; and the password adjustment block is provided with a push-out inclined surface matched with the sloping block.

13. The coded lock according to claim 1, wherein the base plate is provided with two latch hook assemblies which are respectively disposed on two sides of the push switch; each latch hook assembly includes a push rod and a latch hook; the push rod is provided with a connecting body connected with a connecting portion of the push switch and is provided with a plurality of movable recesses; each latch hook includes a limited portion and a hook portion; the limited portions are disposed in the movable recesses; the housing is provided with clamping holes matched with the hook portions; in the case of unlocking and after unlocking, when the push switch is pushed to the left, one latch hook assembly is in the unlocked state and the other latch hook assembly is in the locked state; and when the push switch is pushed to the right, one latch hook assembly is in the locked state and the other latch hook assembly is in the unlocked state.
